(19) United States
(12) Patent Application Publication
(10) Pub. No.: US 2015/0000188 A1
(43) Pub. Date: Jan. 1, 2015

(54) MUSHROOM BED CULTIVATION BAG

(71) Applicant: F. TEC CORPORATION, Nobeoka-shi (JP)

(72) Inventors: Kenichirou SHIRAHANE, Nobeoka-shi (JP); Mamoru SHIRAHANE, Nobeoka-shi (JP)

(21) Appl. No.: 14/313,028

(22) Filed: Jun. 24, 2014

(30) Foreign Application Priority Data
Jun. 28, 2013 (JP) 2013-137145

(51) Int. Cl. A01G 1/04

(52) U.S. Cl. CPC A01G 1/046
USPC 47/1.1

(57) ABSTRACT

Provided is a mushroom bed cultivation bag where a bag main body can be surely torn regardless of nonuniformity of a thickness of a filter, a material, and the like. A mushroom bed cultivation bag includes a vertically long bag main body which has an opened upper end and is formed of a plastic film formed by aligning molecules so that tensile strength of a vertical direction is higher than tensile strength of a horizontal direction, and a rupture handle fused with the bag main body at a position that is different from a position of the bag main body, and rupturing the bag main body to tear the bag main body. A fuse portion fusing the rupture handle with the bag main body is formed in a mountain-shape where a tear-initiation side (opening side of an upper end of the bag main body) faces upward.

### CROSS-REFERENCE TO RELATED APPLICATION

This application claims priority to and the benefit of Japanese Patent Application No. 2013-137145 filed in the Japan Intellectual Property Office on Jun. 28, 2013, the entire contents of which are incorporated herein by reference.

### BACKGROUND

1. Technical Field

The present invention relates to a mushroom bed (artificial medium) cultivation bag used when a mushroom such as a shiitake mushroom or a maitake mushroom is artificially cultivated.

2. Description of the Related Art

When mushroom are artificially cultivated, a mushroom bed cultivation bag formed of a plastic film is commonly used.

In artificial cultivation of the mushrooms using this kind of mushroom bed cultivation bag, first, an artificial medium (mushroom bed) where moisture is adjusted by mixing a wood substrate such as sawdust and a nutrient source such as rice bran is charged in the mushroom bed cultivation bag to be sterilized by high pressure steam or the like, and the mushroom bed is then inoculated with mushroom spawn to perform culturing (culturing step).

In this case, since the mushroom bed cultivation bag is disposably used, the mushroom bed cultivation bag needs to be inexpensive, and it is preferable to manufacture the mushroom bed cultivation bag with a constitution that is as simple as possible.

Further, when mushroom spawn is cultured by using the mushroom bed cultivation bag, air required for growing spawn needs to be supplied to prevent sundry spores from invading.

Further, in artificial cultivation of the mushrooms using the mushroom bed cultivation bag, after the culturing step, a step of drawing the mushroom bed from the mushroom bed cultivation bag to generate the mushrooms [a step of generating the mushroom (fruit body)] is required. However, when the mushroom bed is drawn from the mushroom bed cultivation bag, if the mushroom bed cultivation bag is cut by using a bladed object, there is a risk of damaging the mushroom bed and the like. Accordingly, a material that can be torn by only force of hands so as to prevent the mushroom bed and the like from being damaged is preferably used as the mushroom bed cultivation bag.

A material having the following constitution has been proposed as a mushroom bed cultivation bag satisfying the aforementioned requirement in the related art (for example, refer to Japanese Patent No. 4217256).

As illustrated in FIG. 15, a mushroom bed cultivation bag 100 disclosed in Japanese Patent No. 4217256 includes a bag main body 101 which has an opened upper end and is formed of a plastic film formed by aligning molecules so that tensile strength in a vertical direction is higher than tensile strength in a horizontal direction, a ventilation hole 102 formed in an upper portion of the bag main body 101, and a filter 103 fused with the bag main body 101 while covering the ventilation hole 102, allowing air to pass therethrough, and preventing sundry spores from invading. Further, a stress concentration portion 105 for concentrating peeling stress occurring when the filter 103 is peeled toward a lower end of the bag main body 101 is formed on an uppermost portion of a fuse portion 104 fusing the filter 103 with the bag main body 101.

According to the mushroom bed cultivation bag 100 disclosed in Japanese Patent No. 4217256, as illustrated in FIGS. 15 and 16, a cut-in may be formed in the bag main body 101 by performing a peeling operation toward the lower end of the bag main body 101 while an upper end of the filter 103 is gripped to concentrate peeling stress on the stress concentration portion 105. In addition, after the cut-in is formed in the bag main body 101 by performing the aforementioned operation, if the filter 103 is then tensioned as it is toward the lower end of the bag main body 101, the bag main body 101 may be torn. In this case, in the bag main body 101, only an approximate width portion (portion of an alternate long and two short dashed line) of the fuse portion 104 is peeled from the other portion. In addition, in FIG. 16, reference numeral “106” denotes a peeled portion.

Japanese Patent No. 4217256 is a related art and discloses aforementioned mushroom bed cultivation bag.

The above information disclosed in this Background section is only for enhancement of understanding of the background of the invention and therefore it may contain information that does not form the prior art that is already known in this country to a person of ordinary skill in the art.

### SUMMARY

However, since the thickness of the filter 103 is not uniform, in a constitution of a mushroom bed cultivation bag 100 disclosed in Japanese Patent No. 4217256, the mushroom bed cultivation bag where when the bag main body 101 is torn, only the filter 103 will be damaged may be supplied to a user. That is, only an external portion (external circumference portion) of the fuse portion 104 of the filter 103 is taken and an internal portion of the fuse portion 104 remains, and thus the mushroom bed cultivation bag where the bag main body 101 cannot be torn may be supplied to the user.

Further, a kind of the filter 103 ranges from a material having a coarse mesh to a material having a fine mesh, and the filter 103 may be used while being classified according to a kind of mushroom spawn to be cultured. However, in the case where the mushroom bed cultivation bag 100 disclosed in Japanese Patent No. 4217256 is manufactured by using the filter 103 having the coarse mesh, since strength of the fuse portion 104 is weakened, the filter 103 may be taken when the bag main body 101 is torn, and thus there is a worry about supplying of the mushroom bed cultivation bag where the bag main body 101 cannot be torn to the user. That is, there are some users who want to use the mushroom bed cultivation bag with which the filter 103 having the coarse mesh is fused, but in the constitution of the mushroom bed cultivation bag 100 disclosed in Japanese Patent No. 4217256, there is a problem in that tearing quality of the bag main body 101 varies according to the kind of the filter 103.

The present invention has been made in an effort to provide a mushroom bed cultivation bag where a bag main body can be surely torn regardless of nonuniformity of a thickness of a filter, a material, and the like.

An exemplary embodiment of the present invention provides a constitution of a mushroom bed cultivation bag including:

(1) a bag main body which has an opened upper end and is formed of a plastic film formed by aligning molecules so that tensile strength of a vertical direction is higher than tensile strength of a horizontal direction; a ventilation hole formed in an upper portion of the bag main body; a filter fused with the bag main body while covering the ventilation hole, allowing air to pass therethrough, and preventing sundry spores from invading; and a rupture handle fused with the bag main body at a position that is different from a position of the bag main body, at which the filter is fused, and rupturing the bag main body to tear the bag main body.

In the present invention, the vertical direction means a direction from an opening of the upper end of the bag main body toward a lower end (and an inverse direction thereof).

In the constitution of (1) of the mushroom bed cultivation bag of the present invention, the bag main body is formed of the plastic film formed by aligning the molecules so that tensile strength of the vertical direction is higher than tensile strength of the horizontal direction. That is, the bag main body has a molecule structure which can be easily torn in the vertical direction merely by performing an “initiation operation” of tearing. Therefore, according to the constitution of (1) of the mushroom bed cultivation bag of the present invention, which includes the rupture handle rupturing which is fused with the bag main body at the position that is different from the position of the bag main body, at which the filter is fused, and ruptures the bag main body to tear the bag main body, the bag main body can be ruptured at the position that is different from a position at which the filter is fused by performing a peeling operation in the vertical direction of the bag main body while the rupture handle is gripped, and the bag main body can be easily torn by using this rupturing as the “initiation operation”. That is, according to the constitution of (1) of the mushroom bed cultivation bag of the present invention, the mushroom bed cultivation bag where the bag main body can be surely torn regardless of nonuniformity of a thickness of the filter, a material, and the like can be provided. Accordingly, if the mushroom bed cultivation bag of the present invention is used, a draw-out operation of the mushroom bed from the bag main body required when a culturing step is changed to a mushroom (fruit body) generation step can be more effectively performed. In addition, since the “initiation operation” of tearing is sufficient, a plurality of handles for rupture do not need to be installed in a tearing direction, or a tape-type material according to the tearing direction does not need to be fused with the bag main body by a plurality of fuse portions. In addition, as described above, since the mushroom bed cultivation bag of the present invention has, for example, a simple constitution where a single rupture handle formed of a rectangular plastic film is fused with the bag main body, there is no case of causing an increase in cost.

It is preferable that the mushroom bed cultivation bag of the present invention have the following constitution of (2).

(2) A fuse portion fusing the rupture handle with the bag main body is formed in a mountain-shape where an upside of the mountain-shape is a tear-initiation side.

According to the preferred constitution of (2), a cut-in corresponding to the “initiation operation” of tearing the bag main body may be formed by performing the peeling operation in the vertical direction of the bag main body while the rupture handle is gripped to concentrate peeling stress at a vertical angle portion (stress concentration portion) of the mountain-shape fuse portion fusing the rupture handle with the bag main body. In addition, after the cut-in is formed in the bag main body by performing the aforementioned procedure, if the rupture handle is tensioned as it is in the vertical direction of the bag main body (if force is applied so that the rupture handle is peeled in the vertical direction in which tensile strength of the bag main body is high), the bag main body can be easily torn.

According to the present invention, it is possible to provide a mushroom bed cultivation bag where a bag main body can be surely torn regardless of nonuniformity of a thickness of a filter, a material, and the like. Accordingly, if the mushroom bed cultivation bag of the present invention is used, it is possible to more effectively perform a draw-out operation of a mushroom bed from the bag main body required when a culturing step is changed to a mushroom (fruit body) generation step.

### BRIEF DESCRIPTION OF THE DRAWINGS

FIG. 1 is a front view illustrating a constitution of a mushroom bed cultivation bag according to an exemplary embodiment of the present invention.

FIG. 2 is a front view illustrating a thin tube formed of a plastic film for forming the mushroom bed cultivation bag according to the exemplary embodiment of the present invention (a state where a ventilation hole is formed).

FIG. 3 is a front view illustrating a state where a lower end of the thin tube illustrated in FIG. 2 is sealed by fusing to form a bag.

FIG. 4 is a front view illustrating a state where the ventilation hole of the mushroom bed cultivation bag according to the exemplary embodiment of the present invention is covered by a filter (before the filter is fused with a bag main body).

FIG. 5 is a front view illustrating a state where the filter of the mushroom bed cultivation bag according to the exemplary embodiment of the present invention is fused with the bag main body.

FIG. 6 is a front view illustrating a state where a rupture handle is disposed at a position that is different from that of the filter of the mushroom bed cultivation bag according to the exemplary embodiment of the present invention (before the rupture handle is fused with the bag main body).

FIG. 7 is a perspective view illustrating a state where mushroom spawn is cultured by using the mushroom bed cultivation bag according to the exemplary embodiment of the present invention.

FIG. 8 is a front view illustrating a state where the bag main body of the mushroom bed cultivation bag according to the exemplary embodiment of the present invention is torn.

FIG. 9 is a front view illustrating another constitution of the handle portion for rupture of the mushroom bed cultivation bag according to the exemplary embodiment of the present invention.

FIG. 10 is a front view illustrating yet another constitution of the handle portion for rupture of the mushroom bed cultivation bag according to the exemplary embodiment of the present invention.

FIG. 11 is a front view illustrating another constitution of the mushroom bed cultivation bag according to the exemplary embodiment of the present invention.

FIG. 12 is a front view illustrating yet another constitution of the mushroom bed cultivation bag according to the exemplary embodiment of the present invention.

FIG. 13 is a front view illustrating still another constitution of the mushroom bed cultivation bag according to the exemplary embodiment of the present invention.

FIG. 14 is a perspective view illustrating still yet another constitution of the mushroom bed cultivation bag according to the exemplary embodiment of the present invention.

FIG. 15 is a front view illustrating a constitution of a mushroom bed cultivation bag in the related art.

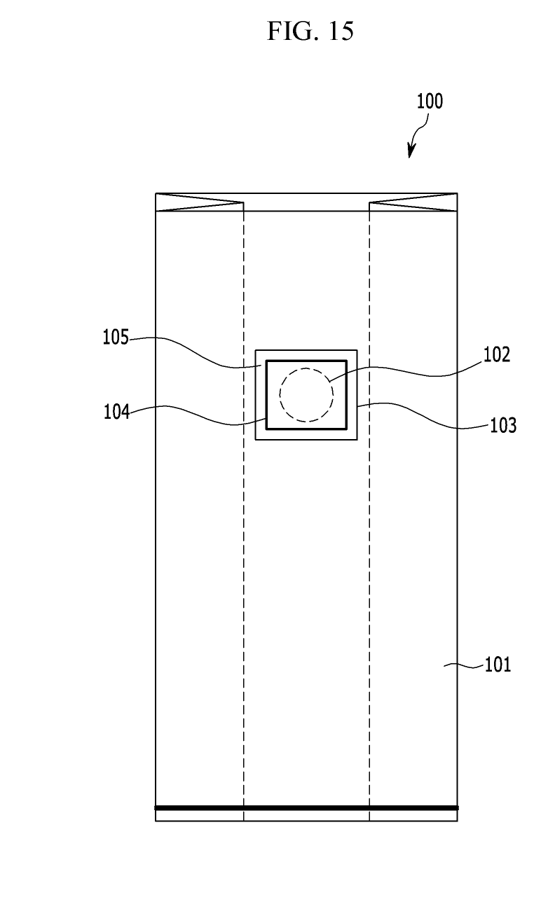

FIG. 16 is a front view illustrating a state where a bag main body of the mushroom bed cultivation bag in the related art is torn.

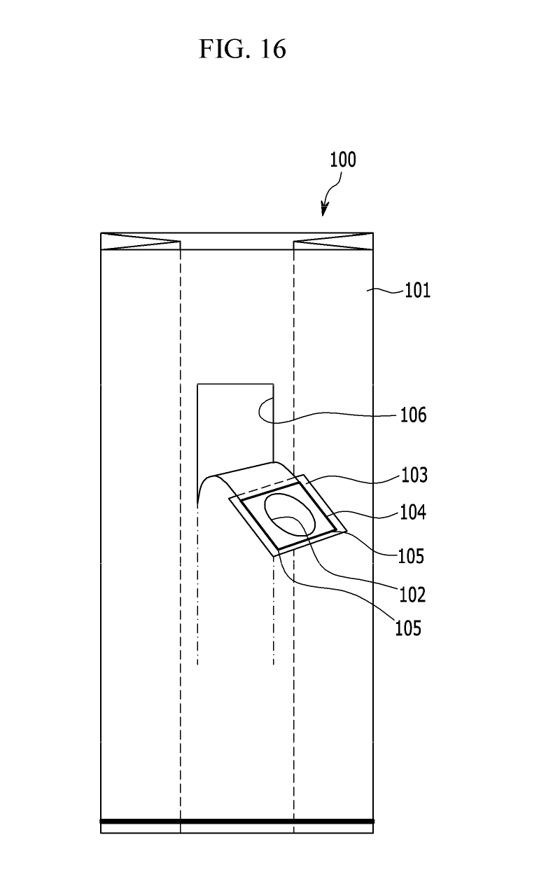

### DETAILED DESCRIPTION OF THE EMBODIMENTS

Hereinafter, the present invention will be described in more detail with reference to preferred exemplary embodiment. However, the following exemplary embodiment is just an example of implementing the present invention, and the present invention is not limited thereto.

### [Constitution of a Mushroom Bed Cultivation Bag]

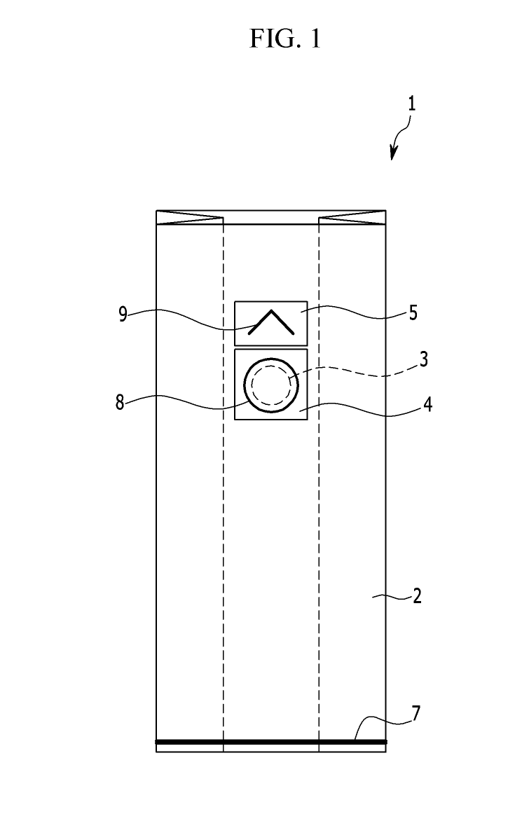

First, the constitution of the mushroom bed cultivation bag according to an exemplary embodiment of the present invention will be described with reference to FIGS. 1 to 7.

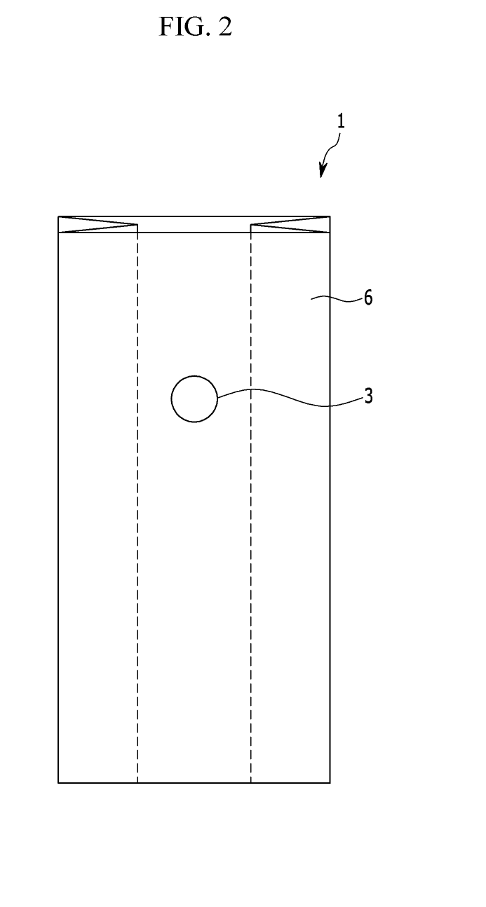

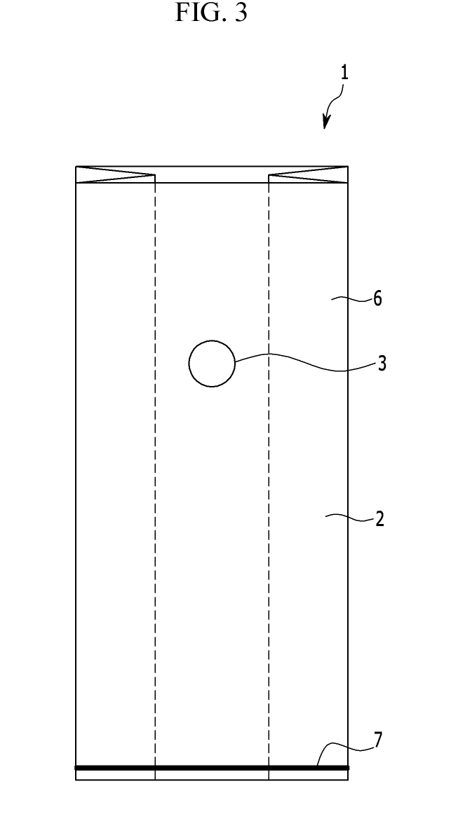

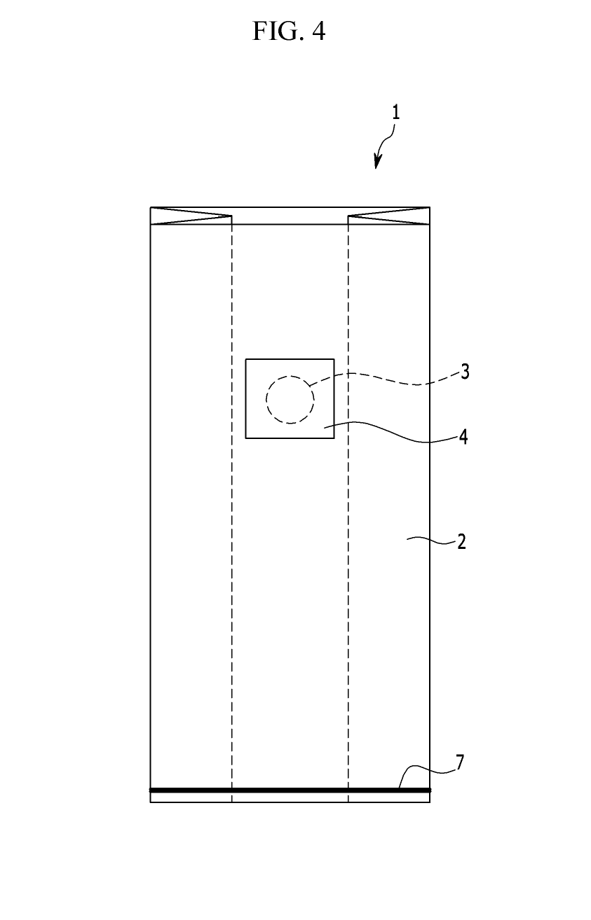

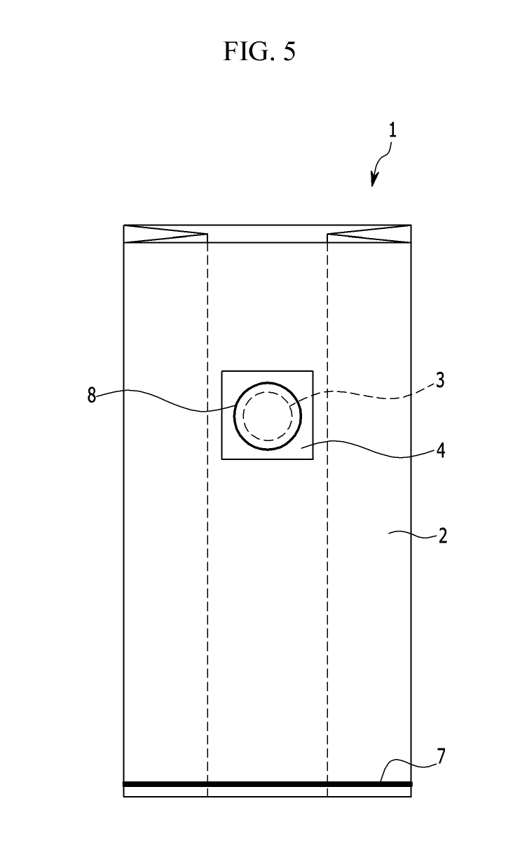

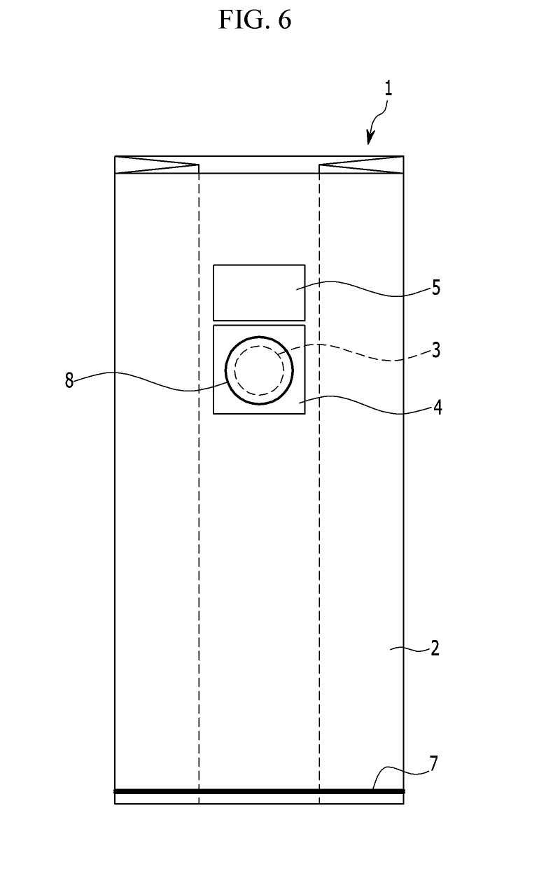

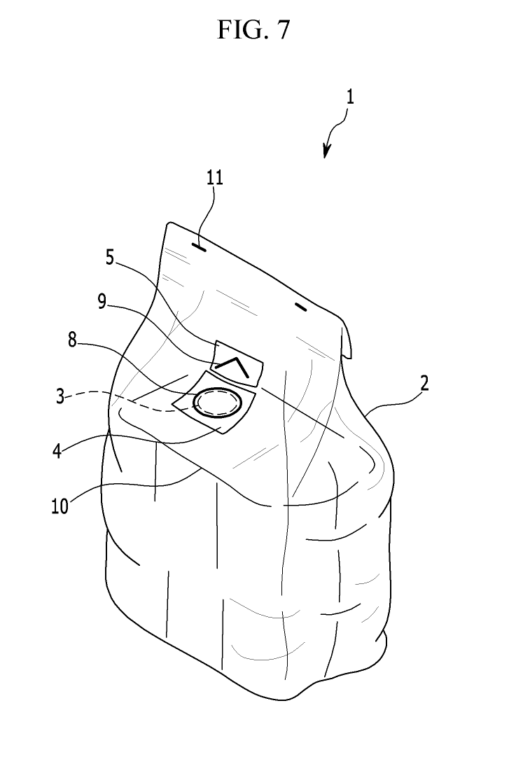

FIG. 1 is a front view illustrating the constitution of the mushroom bed cultivation bag according to the exemplary embodiment of the present invention, FIG. 2 is a front view illustrating a thin tube formed of a plastic film for forming the mushroom bed cultivation bag (a state where a ventilation hole is formed), FIG. 3 is a front view illustrating a state where a lower end of the thin tube illustrated in FIG. 2 is sealed by fusing to form a bag, FIG. 4 is a front view illustrating a state where the ventilation hole of the mushroom bed cultivation bag is covered by a filter (before the filter is fused with a bag main body), FIG. 5 is a front view illustrating a state where the filter of the mushroom bed cultivation bag is fused with the bag main body, FIG. 6 is a front view illustrating a state where a rupture handle is disposed at a position that is different from that of the filter of the mushroom bed cultivation bag (before the rupture handle is fused with the bag main body), and FIG. 7 is a perspective view illustrating a state where mushroom spawn is cultured by using the mushroom bed cultivation bag.

As illustrated in FIG. 1, a mushroom bed cultivation bag 1 according to the present exemplary embodiment includes a vertically long bag main body 2 which has an opened upper end and is formed of a plastic film, a ventilation hole 3 formed in an upper portion of the bag main body 2, a filter 4 fused with the bag main body 2 while covering the ventilation hole 3, allowing air to pass therethrough, and preventing sundry spores from invading, and a rupture handle 5 fused with the bag main body 2 at a position that is different from a position of the bag main body 2, at which the filter 4 is fused. The rupture handle 5 is configured to rupture the bag main body 2 to tear the bag main body 2.

As illustrated in FIGS. 1 to 3, the bag main body 2 is formed in a bag type by folding both sides of a thin tube 6 formed by inflation processing, and sealing a lower end by fusing. In FIGS. 1 and 3, reference numeral 7 denotes a sealing portion. The bag main body 2 having the aforementioned constitution, as illustrated in FIG. 7, is suitable for management thereafter because in the case where an artificial medium (a mushroom bed 10) where moisture is adjusted by mixing a wood substrate such as sawdust and a nutrient source such as rice bran is charged, the mushroom bed 10 may be maintained in an approximately rectangular parallelepiped shape.

A polyolefin-based material such as polypropylene and high density polyethylene, or a polyester-based material, which is inexpensive and can endure sterilization by high pressure steam and the like, is preferable as a material of the bag main body 2. In addition, it is preferable that the bag main body 2 be transparent or semi-transparent so as to observe a culturing state of mushroom spawn.

In the bag main body 2, molecules are aligned so that pinholes and the like are not formed in handling during a general cultivation operation (specifically, a strength ratio at which tensile strength of a vertical direction is 1.3 to 1.4 times higher than tensile strength of a horizontal direction). Herein, the vertical direction means a direction from an opening of an upper end of the bag main body 2 toward a lower end (the sealing portion 7) and an inverse direction thereof.

A thickness of the bag main body 2 (plastic film) is about 40 to 60 μm, a length of the vertical direction of the bag main body 2 when folding is performed like FIG. 1 is about 450 mm, a length of the horizontal direction is about 200 mm, and a folding width of a gusset is about 62 mm.

The ventilation hole 3 is formed to have a circular shape having a diameter of about 40 mm. However, the shape of the ventilation hole is not limited to the circle, and for example, may be any shape such as a rectangle, a polygon, and an oval. Further, the ventilation hole 3 may be positioned over an upper surface of the mushroom bed 10 when the mushroom bed 10 is charged in the bag main body 2 (refer to FIG. 7).

The filter 4 has a rectangular shape having a size of about 55 mm×about 60 mm. However, the shape of the filter is not limited to the rectangle, and for example, may be any shape such as a polygon such as a pentagon, a circle, and an oval. In addition, even if the filter 4 does not completely prevent the sundry spores from invading, the filter 4 is satisfactory as long as the filter 4 sufficiently prevents the sundry spores from invading so as to not negatively affect growth of hypha of the mushroom spawn. In addition, the filter 4 is satisfactory if the filter 4 endures sterilization by high pressure steam and the like and is airtightly fused with the material of the bag main body 2, and for example, a porous plastic filter, a non-woven fabric filter, and the like, which are commercially available, may be used.

As illustrated in FIGS. 1 and 3 to 5, the filter 4 is disposed while covering the ventilation hole 3, and then fused with the bag main body 2. In FIGS. 1 and 5, reference numeral 8 denotes a fuse portion. The position at which the filter 4 is disposed is the upper portion of the bag main body 2, and preferably a position that is not folded when the opening of the upper end of the bag main body 2 is bent in order to prevent the sundry spores from mingling (refer to FIG. 7).

The rupture handle 5 has a rectangular shape having a size of about 30 mm×about 60 mm. However, the shape of the rupture handle 5 is not limited to the rectangle, and for example, may be any shape such as a polygon such as a pentagon, a circle, and an oval. Further, the size of the rupture handle 5 is sufficient if the rupture handle 5 has a size such that it is easily gripped by fingers.

As a material of the rupture handle 5, like the material of the bag main body 2, a polyolefin-based material such as polypropylene and high density polyethylene, a polyester-based material, or the like may be used. In addition, in the case where the same material as the material of the bag main body 2 is used as the material of the rupture handle 5, it is preferable that a thickness of the rupture handle 5 be larger than a thickness of the bag main body 2. The thickness of the rupture handle 5 may be set to be larger than the thickness of the bag main body 2 to easily tear the bag main body 2 by a small force without being influenced by the bag main body 2. In the present exemplary embodiment, the same plastic material as the material of the bag main body 2 is used as the material of the rupture handle 5, and the thickness of the rupture handle 5 is set to about 100 μm which is larger than the thickness of the bag main body 2. In addition, in the case where a material having strength that is larger than that of the material of the bag main body 2 is used as the material of the rupture handle 5, it is not essential for the thickness of the rupture handle 5 to be larger than the thickness of the bag main body 2.

As illustrated in FIGS. 1 and 6, the rupture handle 5 is disposed at the position that is different from that of the filter 4 on the bag main body 2, and then fused with the bag main body 2. In FIG. 1, reference numeral 9 denotes the fuse portion. In addition, the position at which the rupture handle 5 is disposed is not particularly limited, but is preferably a position where it is not folded when the opening of the upper end of the bag main body 2 is bent in order to prevent the sundry spores from mingling (refer to FIG. 7). In the present exemplary embodiment, the rupture handle 5 is disposed at a position that is directly on the position at which the filter 4 is fused (a position at which the ventilation hole 3 is formed).

As described above, in the constitution of the mushroom bed cultivation bag 1 of the present exemplary embodiment, the bag main body 2 is formed of the plastic film formed by aligning the molecules so that tensile strength of the vertical direction is higher than tensile strength of the horizontal direction. That is, the bag main body 2 has a molecule structure which can be easily torn in the vertical direction only by performing the “initiation operation” of tearing the bag main body 2. Therefore, according to the constitution of the mushroom bed cultivation bag 1 of the present exemplary embodiment, which has the rupture handle 5 fused with the bag main body 2 at the position that is different from the position of the bag main body 2, at which the filter 4 is fused, and rupturing the bag main body 2 to tear the bag main body, the bag main body 2 can be ruptured at the position that is different from the position at which the filter 4 is fused by performing the peeling operation in the vertical direction of the bag main body 2 while the rupture handle 5 is gripped, and the bag main body 2 can be easily torn by rupturing as the “initiation operation”. That is, according to the constitution of the mushroom bed cultivation bag 1 of the present exemplary embodiment, the mushroom bed cultivation bag where the bag main body 2 can be surely torn regardless of nonuniformity of a thickness of the filter 4, a material, and the like can be provided. Accordingly, if the mushroom bed cultivation bag 1 of the present exemplary embodiment is used, it is possible to more effectively perform a draw-out operation of the mushroom bed 10 from the bag main body 2 required when a culturing step is changed to a mushroom (fruit body) generation step. In addition, one “initiation operation” of tearing is enough, so that a plurality of handles for rupture need not be installed in a tearing direction, or a tape type of material according to the tearing direction need not be fused with the bag main body by the plurality of fuse portions. In addition, as described above, since the mushroom bed cultivation bag 1 of the present exemplary embodiment has, for example, a simple constitution where a single rupture handle 5 formed of a rectangular plastic film is fused with the bag main body 2, cost is not increased.

A fuse portion 9 fusing the rupture handle 5 with the bag main body 2 is formed in a mountain-shape ( [symbol] ) where a tear-initiation side (opening side of the upper end of the bag main body 2 in FIG. 1) faces upward. To be more specific, the fuse portion 9 is formed of the mountain-shape fuse portion which is formed by combination of two straight-line fuse portions and has a vertical angle of approximately 90° (approximately a right angle), and a portion other than the fuse portion 9 of the rupture handle 5 is spaced apart from the bag main body 2. Since the handle portion 5 for rupture is constituted as described above, a cut-in corresponding to the “initiation operation” of tearing of the bag main body 2 may be formed by performing the peeling operation toward the lower end of the bag main body 2 while the upper end of the rupture handle 5 is gripped by fingers to concentrate peeling stress on the vertical angle portion (stress concentration portion) of the mountain-shape fuse portion 9 fusing the rupture handle 5 with the bag main body 2. In addition, after the cut-in is formed in the bag main body 2 by performing the aforementioned procedure, if the rupture handle 5 is tensioned as it is toward the lower end of the bag main body 2 (if force is applied so that the rupture handle 5 is peeled in the vertical direction in which tensile strength of the bag main body 2 is high), the bag main body 2 can be easily torn.

### [Method of Using the Mushroom Bed Cultivation Bag]

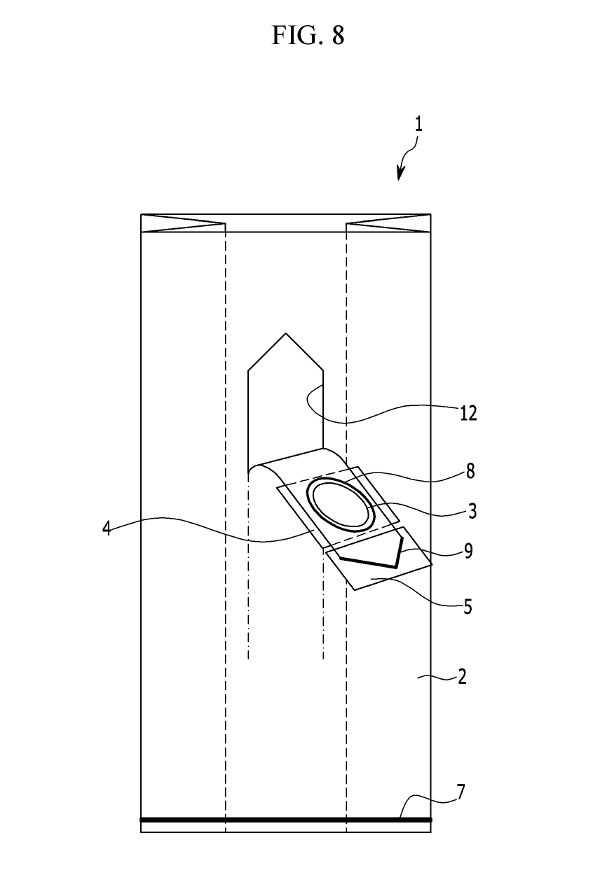

Next, the method of using the mushroom bed cultivation bag according to the exemplary embodiment of the present invention will be described with reference to FIG. 8.

FIG. 8 is a front view illustrating a state where the bag main body of the mushroom bed cultivation bag according to the exemplary embodiment of the present invention is torn.

In artificial cultivation of mushrooms, as illustrated in FIG. 7, first, an artificial medium (mushroom bed 10) where moisture is adjusted by mixing a wood substrate such as sawdust and a nutrient source such as rice bran is charged in the bag main body 2 of the mushroom bed cultivation bag 1 to be sterilized by high pressure steam at about 120° C. for about 2 hours. Next, the sterilized mushroom bed 10 is inoculated with mushroom spawn, the opening of the upper end of the bag main body 2 is bent several times, and fixing is performed with staples 11. In addition, the mushroom bed 10 inoculated with mushroom spawn is charged in the bag main body 2 of the mushroom bed cultivation bag 1, and stored in a culturing room at a temperature of about 24° C. and humidity of about 60% for 30 to 90 days (culturing step).

If hyphae almost fully spread in the mushroom bed 10 (if the culturing step is finished), the mushroom bed 10 is drawn out from the bag main body 2 of the mushroom bed cultivation bag 1, and the mushroom (fruit body) is generated under the environment of a temperature of about 18° C. and humidity of about 90% [mushroom (fruit body) generation step].

When the mushroom bed 10 is drawn from the bag main body 2 of the mushroom bed cultivation bag 1, the bag main body 2 needs to be torn. In the present exemplary embodiment, while the upper end (bent portion) of the bag main body 2 illustrated in FIG. 7 is gripped by one hand, the end of the upper side of the rupture handle 5 is gripped by fingers of the other hand, and the rupture handle 5 is tensioned toward the lower end of the bag main body 2. Thereby, peeling intensity is applied to the mountain-shape fuse portion 9 fusing the rupture handle 5 with the bag main body 2. Therefore, peeling stress is focused on a vertical angle portion of the mountain-shape fuse portion 9 to form the cut-in in the bag main body 2 at the position that is different from the position at which the filter 4 is fused. In addition, after the cut-in is formed in the bag main body 2 at the position that is different from the position at which the filter 4 is fused by performing the aforementioned procedure, if the rupture handle 5 is tensioned as it is toward the lower end of the bag main body 2 [if force is applied so that the rupture handle 5 is peeled in a direction (vertical direction) in which tensile strength of the bag main body 2 is high], as illustrated in FIG. 8, the bag main body 2 may be surely torn regardless of nonuniformity of the thickness of the filter 4, the material, and the like. In this case, in the bag main body 2, only a portion having approximately the same width as a distance between the lower ends (alternate long and two short dash line portion) of the mountain-shape fuse portion 9 is peeled from the other portion. In addition, in FIG. 8, reference numeral 12 denotes a peeled portion.

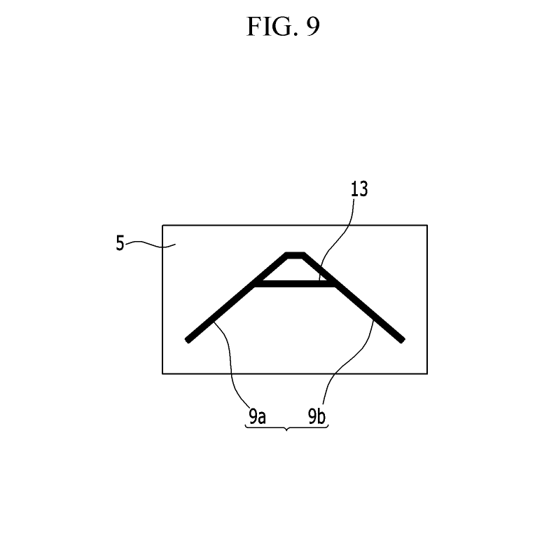

Further, in the aforementioned exemplary embodiment, the case where the vertical angle portion of the mountain-shape fuse portion 9 is sharp is described as an example, but the present invention is not necessarily limited to the aforementioned constitution. The vertical angle portion of the mountain-shape fuse portion 9 may be, for example, as illustrated in FIG. 9, slightly flat. In order to form the cut-in in the bag main body 2 by a small force, it is preferable that a length of a flat portion of the vertical angle portion of the mountain-shape fuse portion 9 be 3 mm or less.

Further, in the aforementioned exemplary embodiment, the mountain-shape fuse portion 9 formed of combination of the two straight-line fuse portions is described as an example, but the present invention is not necessarily limited to the aforementioned constitution. For example, as illustrated in FIG. 9, two straight-line fuse portions 9a and 9b constituting the mountain-shape fuse portion 9 may be connected by a straight-line fuse portion 13 for reinforcement, which is parallel to the lower end of the bag main body 2. In addition, as described above, peeling intensity when the rupture handle 5 is tensioned toward the lower end of the bag main body 2 to be peeled may be applied to only a portion positioned on the straight-line fuse portion 13 for reinforcement of the mountain-shape fuse portion 9 by connecting the two straight-line fuse portions 9a and 9b constituting the mountain-shape fuse portion 9 by the straight-line fuse portion 13 for reinforcement. Therefore, the cut-in can be formed in the bag main body 2 by a small force by increasing peeling stress focused on the vertical angle portion of the mountain-shape fuse portion 9.

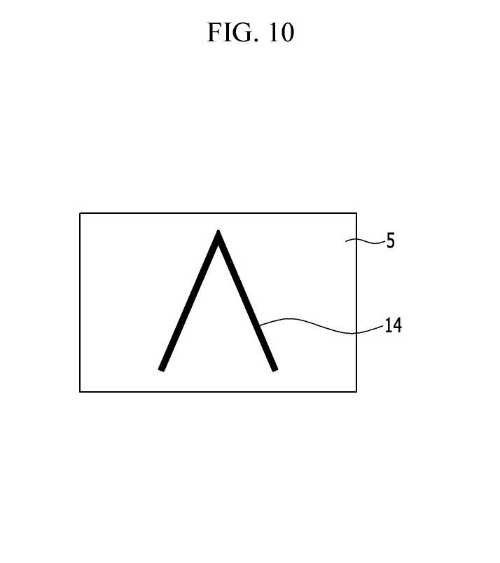

Further, in the aforementioned exemplary embodiment, the mountain-shape fuse portion 9 where the vertical angle is approximately 90° (approximately a right angle) is described as an example, but the present invention is not necessarily limited to the aforementioned constitution. The vertical angle of the mountain-shape fuse portion 9 may be an acute angle, a right angle, or an obtuse angle. Particularly, if the mountain-shape fuse portion 14 where the vertical angle is the acute angle as described in FIG. 10 is adopted, the cut-in can be formed in the bag main body 2 by a small force.

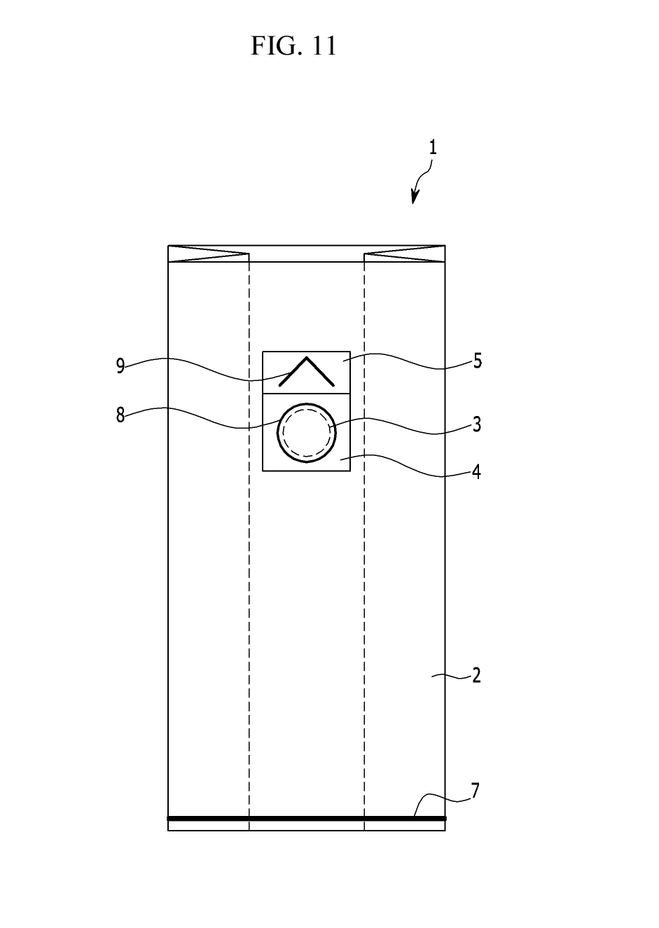

Further, in the aforementioned exemplary embodiment, in an easily comprehensible form on the drawings, the case where the filter 4 and the rupture handle 5 are spaced apart from each other is described as an example, but the present invention is not necessarily limited to the aforementioned constitution. If the rupture handle 5 is fused with the bag main body 2 at the position that is different from the position of the bag main body 2, at which the filter 4 is fused, for example, as illustrated in FIG. 11, an upper edge of the filter 4 may overlap a lower edge of the rupture handle 5.

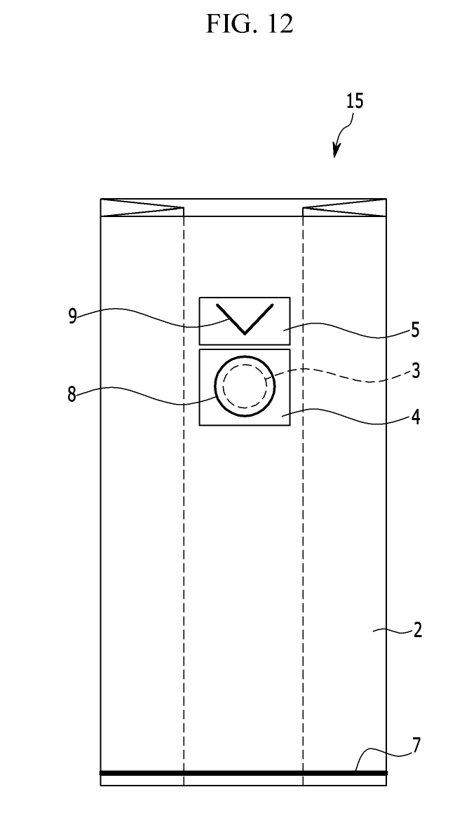

Further, in the aforementioned exemplary embodiment, the case where the fuse portion 9 fusing the rupture handle 5 with the bag main body 2 is formed in a mountain-shape ( [symbol] ) where the upside of the mountain-shape ( [symbol] ) is the tear-initiation side (opening side of the upper end of the bag main body 2 in FIG. 1) is described as an example, but the present invention is not necessarily limited to the aforementioned constitution. For example, like the case of the mushroom bed cultivation bag 15 illustrated in FIG. 12, a fuse portion 16 fusing the rupture handle 5 with the bag main body 2 may be formed in a valley-shape ( [symbol] ) where a lower end side of the bag main body 2 is bottom side. In this case, peeling stress may be focused on two upper ends of the valley-shape fuse portion 16. That is, the two upper ends of the valley-shape fuse portion 16 become a stress concentration portion. In addition, in the case of the valley-shape fuse portion 16, likewise, a vertical angle portion may be slightly flat, and two straight-line fuse portions constituting the valley-shape fuse portion 16 may be connected by the straight-line fuse portion, which is parallel to the lower end of the bag main body 2, for reinforcement.

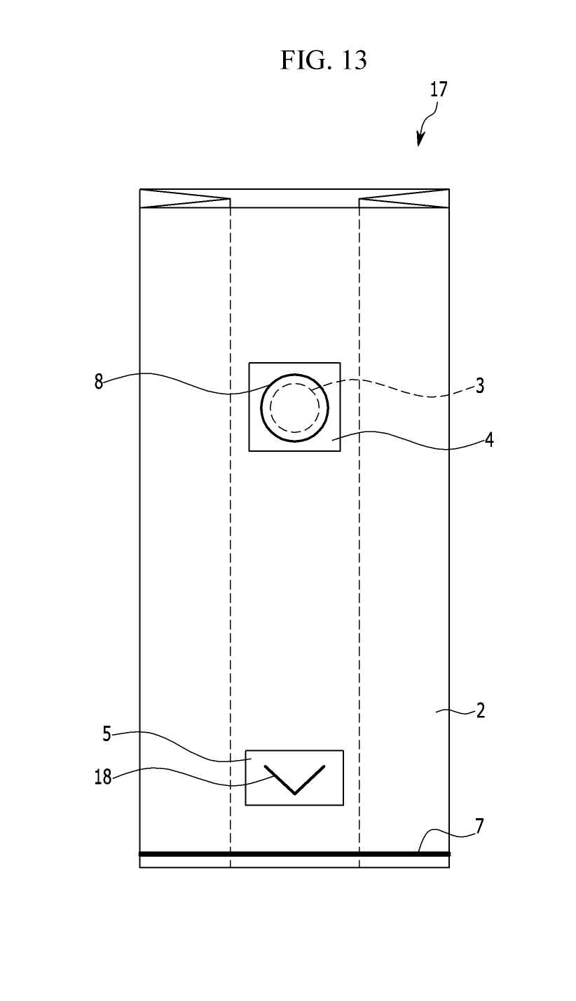

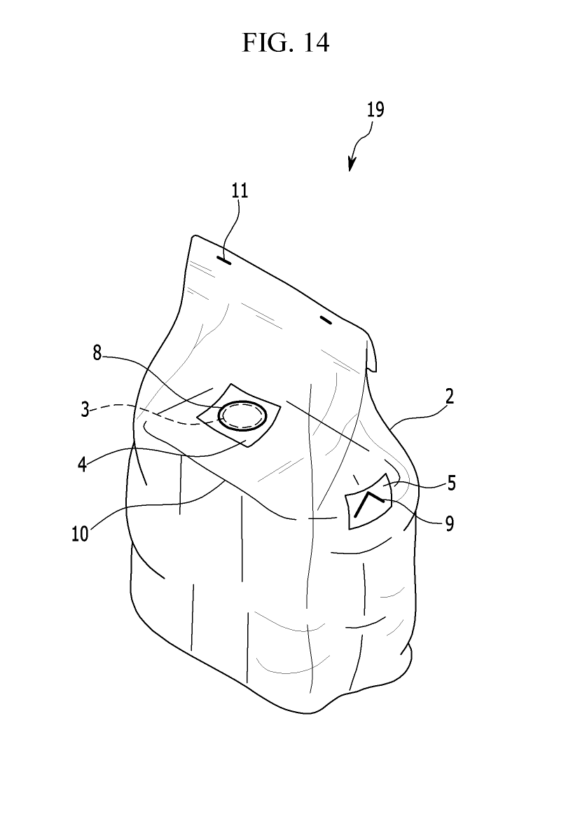

Further, in the aforementioned exemplary embodiment, the case where the rupture handle 5 is disposed at the position that is directly on the position at which the filter 4 is fused (position at which the ventilation hole 3 is formed) is described as an example, but the present invention is not necessarily limited to the aforementioned constitution. For example, like the case of the mushroom bed cultivation bag 17 illustrated in FIG. 13, the rupture handle 5 may be disposed beneath a front surface (surface with which the filter 4 is fused) or a rear surface of the bag main body 2. In this case, a fuse portion 18 fusing the rupture handle 5 with the bag main body 2 is formed in a mountain-shape ( [symbol] ) where a tear-initiation side (lower end side of the bag main body 2 in FIG. 13) faces upward. In addition, in this case, peeling stress may be focused on a vertical angle portion (stress concentration portion) of the mountain-shape fuse portion 18 by performing a peeling operation toward the upper end of the bag main body 2 while the lower end of the rupture handle 5 is gripped by the fingers to form the cut-in corresponding to the “initiation operation” of tearing the bag main body 2. In addition, after the cut-in is formed in the bag main body 2 by performing the aforementioned procedure, if the rupture handle 5 is tensioned as it is moved toward the upper end of the bag main body 2 (if force is applied so that the rupture handle 5 is peeled in the vertical direction in which tensile strength of the bag main body 2 is large), the bag main body 2 can be easily torn. Further, like the case of the mushroom bed cultivation bag 19 illustrated in FIG. 14, the rupture handle 5 may be disposed on an upper portion (or lower portion) of a lateral surface of the bag main body 2. In the case where the rupture handle 5 is disposed on the upper portion of the lateral surface of the bag main body 2, it is preferable that the fuse portion 9 fusing the rupture handle 5 with the bag main body 2 be formed in a mountain-shape ( [symbol] ) where an upper end side of the tear-initiation side (bag main body 2) faces upward. Further, in the case where the rupture handle 5 is disposed on the lower portion of the lateral surface of the bag main body 2, it is preferable that the fuse portion fusing the rupture handle 5 with the bag main body 2 be formed in a mountain-shape ( [symbol] ) where the tear-initiation side (lower end side of the bag main body 2)] faces upward.

Further, in the aforementioned exemplary embodiment, the case where the fuse portion fusing the rupture handle 5 with the bag main body 2 is formed in one mountain-shape ( [symbol] ) fuse portion or valley-shape ( [symbol] ) fuse portion is described as an example, but the present invention is not necessarily limited to the aforementioned constitution. For example, two or more mountain-shape ( [symbol] ) fuse portions or valley-shape ( [symbol] ) fuse portions may be consecutively formed.

Further, in the aforementioned exemplary embodiment, the case where the fuse portion fusing the rupture handle 5 with the bag main body 2 is formed in the mountain-shape ( [symbol] ) or the valley-shape ( [symbol] ) is described as an example, but the present invention is not necessarily limited to the aforementioned constitution. The fuse portion fusing the rupture handle 5 with the bag main body 2 may have any shape as long as the fuse portion has a corner portion for focusing peeling stress.

### INDUSTRIAL APPLICABILITY

According to the present invention, it is possible to provide a mushroom bed cultivation bag where a bag main body can be surely torn regardless of nonuniformity of a thickness of a filter, a material, and the like. Accordingly, the mushroom bed cultivation bag of the present invention is advantageous in that novel efficiency of a draw-out operation of a mushroom bed from the bag main body, which is required when a culturing step is changed to a mushroom (fruit body) generation step, is promoted.

### DESCRIPTION OF SYMBOLS

1, 15, 17, 19 Mushroom bed cultivation bag

2 Bag main body

3 Ventilation hole

4 Filter

5 Rupture handle

6 Thin tube

7 Sealing portion

8 Fuse portion

9, 14, 18 Mountain-shape fuse portion

9a, 9b, 13 Straight-line fuse portion

10 Mushroom bed

11 Stapler's staple

12 Peeled portion

16 Valley-shape fuse portion

What is claimed is:

1. A mushroom bed cultivation bag comprising:
a bag main body which has an opened upper end and is formed of a plastic film formed by aligning molecules so that tensile strength of a vertical direction is higher than tensile strength of a horizontal direction;
a ventilation hole formed in an upper portion of the bag main body;
a filter fused with the bag main body while covering the ventilation hole, allowing air to pass therethrough, and preventing sundry spores from invading; and
a rupture handle fused with the bag main body at a position that is different from a position of the bag main body, at which the filter is fused, the rupture handle is configured to rupture the bag main body to tear the bag main body.

2. The mushroom bed cultivation bag of claim 1, wherein
a fuse portion fusing the rupture handle with the bag main body is formed in a mountain-shape where an upside of the mountain-shape is a tear-initiation side.
